(19) United States
(12) Patent Application Publication
(10) Pub. No.: US 2016/0372064 A1
(43) Pub. Date: Dec. 22, 2016

(54) DISPLAY DRIVING METHOD, DISPLAY DRIVING CIRCUIT AND LIQUID CRYSTAL DISPLAY

(71) Applicant: SHENZHEN CHINA STAR OPTOELECTRONICS TECHNOLOGY CO., LTD., Shenzhen City, Guangdong (CN)

(72) Inventors: Yu-yeh CHEN, Shenzhen, Guangdong (CN); Wenqin ZHAO, Shenzhen, Guangdong (CN)

(73) Assignee: Shenzhen China Star Optoelectronics Technology Co., Ltd., Shenzhen, Guangdong (CN)

(21) Appl. No.: 14/437,494

(22) PCT Filed: Jan. 28, 2015
(86) PCT No.: PCT/CN2015/071703

§ 371 Date: Apr. 21, 2015

(30) Foreign Application Priority Data
Dec. 31, 2014 (CN) 201410856449.8

(51) Int. Cl. G09G 3/36

(52) U.S. Cl. CPC G09G 3/3648; G09G 2330/023; G09G 2310/0243

(57) ABSTRACT

The present invention discloses a display driving method, a display driving circuit and a liquid crystal display. The method comprises steps of: inputting the display data corresponding to the picture frame, and the picture frame comprises a plurality of pixels; statistically summing absolute values of gray scale/voltage differences of the pixels in a showing sequence direction of the plurality of pixels to acquire pixel gray scale/voltage distribution of the plurality of pixels according to the gray scale/voltage difference after summing; at least partially reducing fore and after driving voltage difference corresponded with the display data of fore and after showing pixels in a showing sequence direction of the plurality of pixels for pixel gray scale/voltage distribution of the plurality of pixels of which the gray scale/voltage difference after summing is larger than the threshold. With the aforesaid arrangement, the present invention can reduce the power consumption of the display driving circuit.

### FIELD OF THE INVENTION

The present invention relates to a display technology field, and more particularly to a display driving method, a display driving circuit and a liquid crystal display.

### BACKGROUND OF THE INVENTION

The driving type of Thin Film Transistor (TFT) in the present liquid crystal display is: the gate driving circuit of the display scans each row of pixels on the display panel row by row, and the source driving circuit is synchronous with the scan of the gate driving circuit to output the driving voltage for the row of the pixels which is scanned by the gate driving circuit to make the row of the pixels show corresponding gray scale.

However, as the liquid crystal display shows different pictures, the difference between the driving voltages required for the adjacent rows or the alternate rows of the picture can be larger. Then, if the scan row by row remains, the difference between the driving voltages for at least half of adjacent twice inputs of the source driving circuit can be larger, and thus, it leads to that the power consumption of the source driving circuit is high.

### SUMMARY OF THE INVENTION

A technical issue that the present invention is mainly to solve is to provide a display driving method, a display driving circuit and a liquid crystal display, which can reduce the power consumption of the display driving circuit.

For solving the aforesaid technical issue, the technical solution employed by the present invention is: providing a display driving method comprising steps of: inputting the display data corresponding to the picture frame, and the picture frame comprises a plurality of pixels; statistically summing absolute values of gray scale/voltage differences of the pixels in a showing sequence direction of the plurality of pixels to acquire pixel gray scale/voltage distribution of the plurality of pixels according to the gray scale/voltage difference after summing; at least partially reducing fore and after driving voltage difference corresponded with the display data of fore and after showing pixels in a showing sequence direction of the plurality of pixels for pixel gray scale/voltage distribution of the plurality of pixels of which the gray scale/voltage difference after summing is larger than the threshold.

The step of statistically summing absolute values of gray scale/voltage differences of the pixels in a showing sequence direction of the plurality of pixels comprises: as rank scan driving and showing the plurality of pixels, summing absolute values of driving voltage differences required for pixels of the next row and the present row on the same data line in the plurality of pixels row by row; as the voltage difference Δ U1 after summing is larger than the first threshold value G_th1, the pixel voltage distribution of the plurality of pixels is determined to be the first kind of distribution.

The step of statistically summing absolute values of gray scale/voltage differences of the pixels in a showing sequence direction of the plurality of pixels comprises: as rank scan driving and showing the plurality of pixels, summing absolute values of driving voltage differences required for pixels of the row after the next row and the present row on the same data line in the plurality of pixels row by row; as the voltage difference Δ U2 after summing is larger than the second threshold value G_th2, the pixel voltage distribution of the plurality of pixels is determined to be the second kind of distribution.

The step of at least partially reducing fore and after driving voltage difference corresponded with the display data of fore and after showing pixels in the showing sequence direction of the plurality of pixels comprises: as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

The step of at least partially reducing fore and after driving voltage difference corresponded with the display data of fore and after showing pixels in the showing sequence direction of the plurality of pixels comprises: as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

For solving the aforesaid technical issue, another technical solution employed by the present invention is: providing a display driving circuit comprising: an input module, employed for inputting the display data corresponding to the picture frame, and the picture frame comprises a plurality of pixels; a statistical module, employed for statistically summing absolute values of gray scale/voltage differences of the pixels in a showing sequence direction of the plurality of pixels to acquire pixel gray scale/voltage distribution of the plurality of pixels according to the gray scale/voltage difference after summing; a driving module, at least partially reducing fore and after driving voltage difference corresponded with the display data of fore and after showing pixels in a showing sequence direction of the plurality of pixels for pixel gray scale/voltage distribution of the plurality of pixels of which the gray scale/voltage difference after summing is larger than the threshold.

The statistical module is specifically employed for: as rank scan driving and showing the plurality of pixels, summing absolute values of driving voltage differences required for pixels of the next row and the present row on the same data line in the plurality of pixels row by row; as the voltage difference Δ U1 after summing is larger than the first threshold value G_th1, the pixel voltage distribution of the plurality of pixels is determined to be the first kind of distribution.

The statistical module is specifically employed for: as rank scan driving and showing the plurality of pixels, summing absolute values of driving voltage differences required for pixels of the row after the next row and the present row on the same data line in the plurality of pixels row by row; as the voltage difference Δ U2 after summing is larger than the second threshold value G_th2, the pixel voltage distribution of the plurality of pixels is determined to be the second kind of distribution.

The step of at least partially reducing fore and after driving voltage difference corresponded with the display data of fore and after showing pixels in the showing sequence direction of the plurality of pixels specifically comprises: as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

The step of at least partially reducing fore and after driving voltage difference corresponded with the display data of fore and after showing pixels in the showing sequence direction of the plurality of pixels specifically comprises: as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

For solving the aforesaid technical issue, another technical solution employed by the present invention is: providing a liquid crystal display, comprising a display driving circuit and a display panel, and the display driving circuit is the aforesaid display driving circuit, and the display driving circuit outputs a driving voltage corresponding to display data of a picture frame to the display panel to drive the display panel to show a picture corresponding to the picture frame.

The benefits of the present invention are: different from the condition of prior arts, the present invention statistically sums absolute values of gray scale/voltage differences of the pixels in a showing sequence direction of the pixels of the picture frame to acquire pixel gray scale/voltage distribution of the picture frame, and at least partially reduces fore and after driving voltage difference corresponded with the display data of fore and after showing pixels in the showing sequence direction of the plurality of pixels for pixel gray scale/voltage distribution of the plurality of pixels of which the gray scale/voltage difference after summing is larger than the threshold. Thus, the driving voltage change that the display driving circuit outputs to the portion of the fore and after showing pixels is diminished, and the power consumption of the display driving circuit is reduced.

### BRIEF DESCRIPTION OF THE DRAWINGS

FIG. 1 is a structural diagram of a liquid crystal display device according to the present invention;

FIG. 2 is a flowchart of a display driving method according to one embodiment of the present invention;

FIG. 3 is a flowchart of a display driving method according to another embodiment of the present invention;

FIG. 4 is first diagram of a portion of scan signals outputted from the display driving circuit according to the present invention;

FIG. 5 is second diagram of a portion of scan signals outputted from the display driving circuit according to the present invention;

FIG. 6 is a diagram of partial picture corresponded with picture frame in another embodiment of the display driving method according to the present invention;

FIG. 7 is a diagram of which shows that the driving circuit drives the display panel partial in accordance with FIG. 6 that picture corresponded with picture frame in another embodiment of the display driving method according to the present invention;

FIG. 8 is a structural diagram of one embodiment of the display driving circuit according to the present invention.

### DETAILED DESCRIPTION OF PREFERRED EMBODIMENTS

In the following descriptions, for explanation but not limitation, the specific details, such as particular system structures, connects and skills are proposed for carefully and thoroughly understanding the present invention. Nevertheless, any persons who are skilled in the art should clearly understand that the present application can be achieved without the specific details in other embodiments. In other circumstances, the detail descriptions of the well known devices, circuits and methods are omitted to avoid that the unnecessary details hinder the description of the present application.

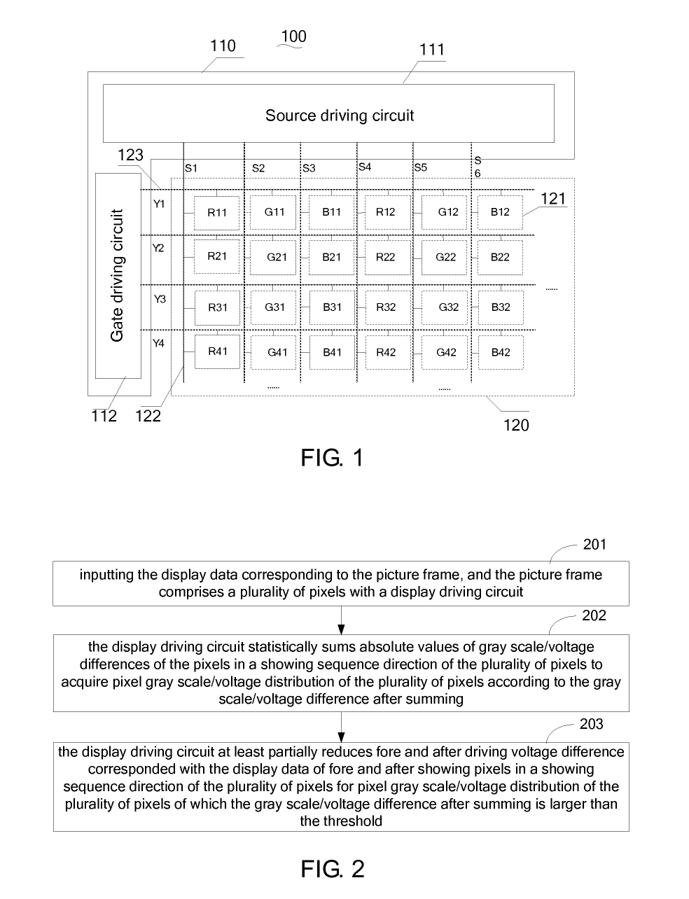

Please refer to FIG. 1. FIG. 1 is a structural diagram of a liquid crystal display device according to the present invention. In this embodiment, the liquid crystal display 100 comprises a display driving circuit 110 and a display panel 120.

The display panel 120 comprises a plurality of pixel units 121, a plurality of data lines 122 and a plurality of scan lines 123. In this embodiment, the pixel unit 121 is driven by TFT. Each data line 122 is arranged in column, and separately connected to one column of pixel units 121 to output the data signal provided by the display driving circuit 110 to the pixel units 121 of the column. Each scan line 123 is arranged in row, and separately connected to one row of pixel units 121 to output the scan signal provided by the display driving circuit 110 to the pixel units 121 of the row.

The display driving circuit 110 comprises a source driving circuit 111 and a gate driving circuit 112, and after the display driving circuit 110 inputs display data of a picture frame, the source driving circuit 111 inputs driving voltages for all pixels of the picture frame to the corresponding pixel units 121 via the data lines 122, and the gate driving circuit 112 outputs scan signals via the scan lines 123 to activate the corresponding pixel units to realize that the display drive circuit 110 drives the display panel 120 to show the picture corresponding to the picture frame. Specifically, the display driving circuit 110 executes the display driving method of the present invention to realize that the display panel 120 is driven to show the picture corresponding to the picture frame.

Please refer to FIG. 2. FIG. 2 is a flowchart of a display driving method according to one embodiment of the present invention. The display driving circuit 110 executes the method of this embodiment to realize that the display panel 120 is driven to show the picture corresponding to the picture frame. Specifically, the method comprises:

step 1, inputting the display data corresponding to the picture frame, and the picture frame comprises a plurality of pixels with a display driving circuit.

The display driving circuit receives display data of the picture frame to be shown, wherein the picture frame comprises the plurality of pixels, and the plurality of pixels correspond to the plurality of pixel units of the display panel.

step 102: the display driving circuit statistically sums absolute values of gray scale/voltage differences of the pixels in a showing sequence direction of the plurality of pixels to acquire pixel gray scale/voltage distribution of the plurality of pixels according to the gray scale/voltage difference after summing.

A showing sequence of the plurality of pixels is the sequence that the display driving circuit drives the corresponding pixel units of the display panel. For instance, the display driving circuit utilizes row driving, and the showing sequence of the plurality of pixels is to show by rows.

The liquid crystal display shown in FIG. 1 is illustrated, and the showing sequence of the plurality of pixels is to show by rows. The display driving circuit divides the plurality of pixels into pixel areas, and each pixel area comprises the pixels on at least one data line. The display driving circuit respectively calculates gray scale/voltage differences of the pixels in each pixel area in the showing sequence direction and statistically sums absolute values of gray scale/voltage differences of all the pixels in each pixel area. Specifically, the absolute values of gray scale differences required for the pixels of the next row and the present row in each pixel unit are calculated row by row to obtain the absolute value sum of the gray scale differences of the pixels on the adjacent scan lines in each pixel area,

$$Δ Gary = {\sum }_{n} \vert Gary ( n ) \text{-} Gary ( n - 1 ) \vert$$

and Gary(n) represents the sum of the gray scale values of all the pixels on the nth scan line in the said pixel area, and n is a number from 2 to the total number of the scan lines of the display panel; and/or the absolute values of gray scale differences required for the pixels of the row after the next row and the present row in each pixel unit are calculated row by row to obtain the absolute value sum of the gray scale differences of the pixels on the alternate lines in each pixel area,

$$Δ Gary = {\sum }_{n} \vert Gary ( n ) \text{-} Gary ( n - 2 ) \vert$$

and Gary(n) represents the sum of the gray scale values of all the pixels on the nth scan line in the said pixel area, and n is a number from 3 to the total number of the scan lines of the display panel.

The pixel gray scale/voltage distribution of the pixels in each pixel area is acquired according to the sum of the absolute values of the gray scale/voltage differences of the pixels in each pixel area. Specifically, as the sum of the absolute values of the gray scale differences of the pixels on the adjacent rows in each pixel area exceeds a threshold, the gray scale differences of the pixels on the adjacent rows in each pixel area are all confirmed to be larger.

step 103, the display driving circuit at least partially reduces fore and after driving voltage difference corresponded with the display data of fore and after showing pixels in a showing sequence direction of the plurality of pixels for pixel gray scale/voltage distribution of the plurality of pixels of which the gray scale/voltage difference after summing is larger than the threshold.

The step of at least partially reducing fore and after driving voltage difference corresponded with the display data of fore and after showing pixels in this embodiment can be processed by changing the driving sequence of a portion of the pixels or by discarding display data to the driving voltage differences corresponded with the display data of the portion of the pixels.

For instance, as the sum of the absolute values of the gray scale differences of the pixels on the adjacent rows in each pixel area exceeds a threshold, the pixel areas of which the gray scale differences of the pixels on the adjacent rows are larger are confirmed to be existing in the plurality of pixels. Thus, the pixels on the odd scan lines in the plurality of pixels can be driven first, and then the pixels on the even scan lines are driven, and alternatively, the pixels on every 2i adjacent scan lines in the plurality of pixels are considered as an unit, and i is larger than 1, and the display driving circuit sequentially drives each unit, and each unit is fore and after driven according to the odd and even scan lines.

For another instance, as the sum of the absolute values of the gray scale differences of the pixels on the alternate rows in each pixel area exceeds a threshold, the pixel areas of which the gray scale differences of all the pixels on the alternate rows are larger are confirmed to be existing in the plurality of pixels. Thus, the pixels on the 4jth scan line and (4j−1)th scan lines in the plurality of pixels can be driven first, and then the pixels on the rest scan lines are driven, and alternatively, the display driving circuit considers the pixels on every 4 adjacent scan lines in the plurality of pixels as an unit, and sequentially drives each unit, and adjacent two units are driven by driving voltages of the pixels on two different scan lines.

In practical application, the number of the source driving circuits in the display driving circuit can be many, and each source driving circuit drives the pixel units on a portion of the data lines of the display panel. Then, preferably, the display driving circuit can considers the pixel units correspondingly driven by each source driving circuit as one pixel area. With performing the aforesaid step 102, the gray scale/voltage distribution of the pixel units driven by the each source driving circuit can be confirmed. Thus, as the gray scale/voltage distribution of which the gray scale/voltage differences after summing of the pixel units driven by one source driving circuit is larger than the threshold exists, then the step 103 is executed. By at least changing the driving sequence of the pixels driven by the source driving circuit of which the gray scale/voltage distribution exists or by discarding display data to the pixels driven by the source driving circuit of which the gray scale/voltage distribution exists, it is achieved to at least partially reduce fore and after driving voltage difference corresponded with the display data of fore and after showing pixels of the source driving circuit of which the gray scale/voltage distribution exists.

It is understandable that the aforesaid illustration is combined with the display panel shown in FIG. 1. Each scan line of the display panel is connected to pixel units of a row, and each scan line comprises the pixel units of all the pixel areas thereon. Consequently, as the gray scale/voltage difference after summing of the pixel area in the plurality of pixels is larger than the threshold, the pixels on the scan line in the all pixel areas are adjusted as the display driving circuit adjusts the driving sequence on the scan line or discards display data. In other embodiments, supposing the scan line of the display panel is not connected to the pixel units of the entire row, such as each scan line is only connected to one or three pixel units of the display panel, as the gray scale/voltage difference after summing of the pixel area in the plurality of pixels is larger than the threshold, the display driving circuit can change the driving sequence of the pixels connected to the scan line only in the pixel area of which the gray scale/voltage difference after summing of the pixel area is larger than the threshold, or discard display data to the pixels connected to the scan line in the pixel area of which the gray scale/voltage difference after summing of the pixel area is larger than the threshold.

In this embodiment, the present invention statistically sums absolute values of gray scale/voltage differences of the pixels in a showing sequence direction of the pixels of the picture frame to acquire pixel gray scale/voltage distribution of the picture frame, and at least partially reduces fore and after driving voltage difference corresponded with the display data of fore and after showing pixels in the showing sequence direction of the plurality of pixels for pixel gray scale/voltage distribution of the plurality of pixels of which the gray scale/voltage difference after summing is larger than the threshold. Thus, the driving voltage change that the display driving circuit outputs to the portion of the fore and after showing pixels is diminished, and the power consumption of the display driving circuit is reduced.

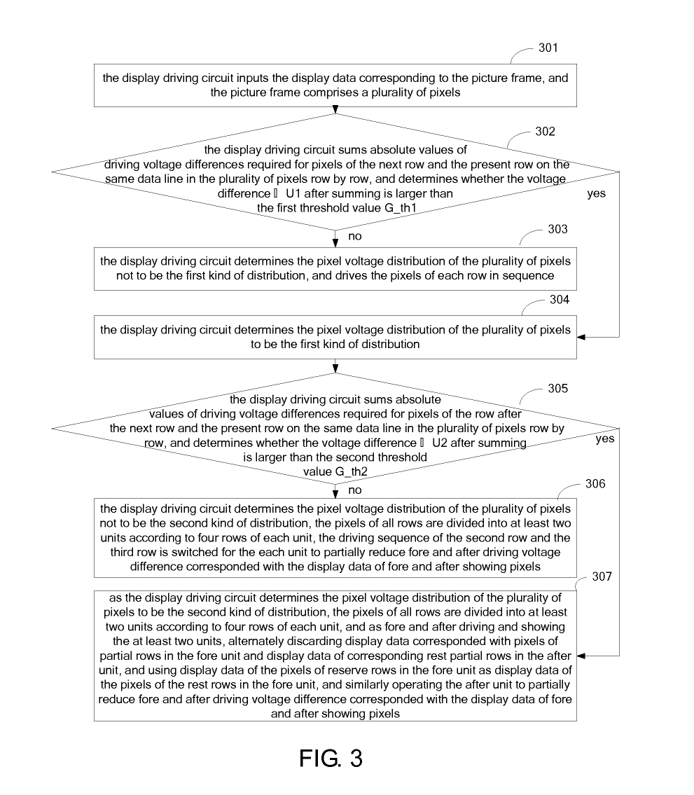

Please refer to FIG. 1 and FIG. 3. FIG. 3 is a flowchart of a display driving method according to another embodiment of the present invention. In this embodiment, the display driving method remains to be implemented by the display driving circuit 110 shown in FIG. 1, which is employed to drive the display panel 120 shown in FIG. 1, i.e. the display driving circuit 110 utilizes rank scan driving to drive the pixel units 121 of the display panel.

Specifically, the method comprises:

301: the display driving circuit inputs the display data corresponding to the picture frame, and the picture frame comprises a plurality of pixels.

The display driving circuit 110 receives display data of the picture frame to be shown, wherein the picture frame comprises the plurality of pixels, and the plurality of pixels correspond to the plurality of pixel units 121 of the display panel 120.

302: the display driving circuit sums absolute values of driving voltage differences required for pixels of the next row and the present row on the same data line in the plurality of pixels row by row, and determines whether the voltage difference Δ U1 after summing is larger than the first threshold value G_th1, and if no, then executes step 303, and if yes, then executes step 304.

In this embodiment, the display driving circuit comprises a plurality of source driving circuits, and the display driving circuit divides the pixels driven by each source driving circuit into one pixel area. The display driving circuit sums the absolute values of gray scale differences required for the pixels of the next row and the present row in each pixel unit row by row,

$$Δ U 1 = u {\sum }_{n} \vert Gary ( n ) \text{-} Gary ( n - 1 ) \vert$$

and Gary(n) represents the sum of the gray scale values of all the pixels on the nth line in the said pixel area, and n is a number from 2 to the total number of lines of the pixels, and u is a convert constant between the gray scale and driving voltage. The display driving circuit directly determines whether the voltage difference Δ U1 after summing in each pixel area is larger than the first threshold value G_th1. Certainly, in other embodiments, the display driving circuit can determines whether the driving voltage difference of the pixels on the same data line of each adjacent rows in the pixel area is larger than a threshold, and if the driving voltage difference of the pixels on the same data line of adjacent rows exceeding an predetermined amount in the pixel area is larger than a threshold, and then the voltage difference Δ U1 after summing is determined to be larger than the first threshold value G_th1.

303: the display driving circuit determines the pixel voltage distribution of the plurality of pixels not to be the first kind of distribution, and drives the pixels of each row in sequence.

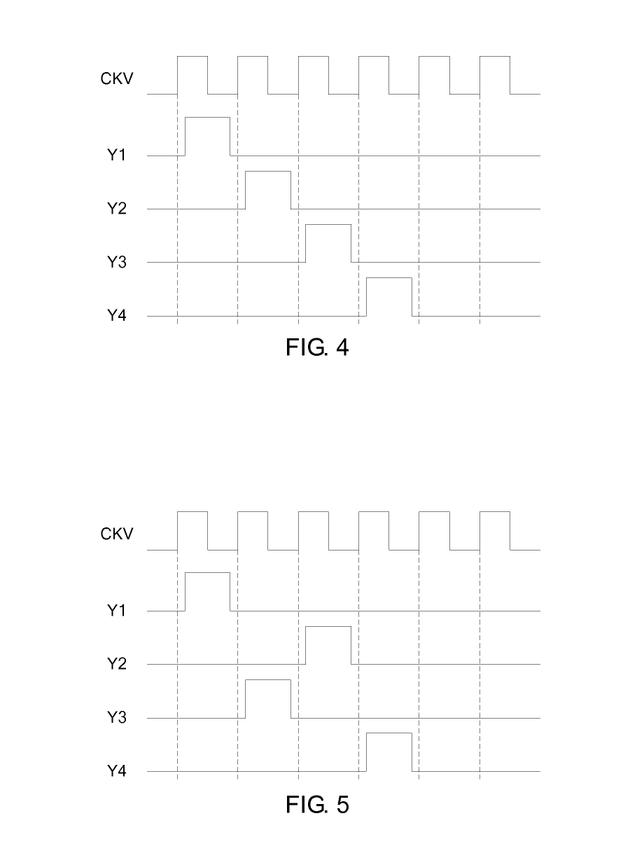

As the pixel area of which the voltage difference Δ U1 after summing is larger than the first threshold value G_th1 in the plurality of pixels does not exist, the display driving circuit determines the pixel voltage distribution of the plurality of pixels not to be the first kind of distribution. That is to say, the driving voltage difference of the pixels of adjacent rows in the inputted picture frame is smaller, and therefore, the gate driving circuit of the display driving circuit outputs scan signals as shown in FIG. 4 corresponding to the output end of each scan line, to scan the plurality of pixels in sequence row by row, and the source driving circuit outputs driving voltage of the pixels of corresponding row in accordance with the sequence of the gate driving circuits according to the pixel gray scale of the picture frame to realize showing the picture represented by the picture frame. For instance, as the gate driving circuit outputs a scan signal Y1 to activate the pixels of the first row, the source driving circuit outputs the driving voltage of the pixels of the first row, and as the gate driving circuit outputs a scan signal Y2 to activate the pixels of the second row, the source driving circuit outputs the driving voltage of the pixels of the second row, and so on. As the scan signal Yn in FIG. 4 is high voltage level, the pixels of the nth row are activated, and CKV represents the sequence signal.

Because the driving voltage difference of the adjacent each output of the source driving circuit is smaller, according to the power consumption of the source driving circuit, P=½C□f·ΔU², f is the voltage change frequency of the source driving circuit, and Δ U is the voltage difference change of the source driving circuit output, and thus, it can be derived that the power consumption of the source driving circuit is correspondingly smaller.

304: the display driving circuit determines the pixel voltage distribution of the plurality of pixels to be the first kind of distribution.

As the pixel area of which the voltage difference Δ U1 after summing is larger than the first threshold G_th1 exists in the plurality of the pixels, the display driving circuit determines the pixel voltage distribution of the plurality of the pixels to be the first kind of distribution. That is to say, the driving voltage difference of the pixels of adjacent rows in the inputted picture frame is larger.

305: the display driving circuit sums absolute values of driving voltage differences required for pixels of the row after the next row and the present row on the same data line in the plurality of pixels row by row, and determines whether the voltage difference Δ U2 after summing is larger than the second threshold value G_th2, and if no, then executes step 306, and if yes, then executes step 307.

In this embodiment, as the display driving circuit determines the pixel voltage distribution of the plurality of the pixels to be the first kind of distribution, and then, the display driving circuit sums the absolute values of gray scale differences required for the pixels of the row after the next row and the present row in each pixel unit row by row,

$$Δ U 1 = u {\sum }_{n} \vert Gary ( n ) \text{-} Gary ( n - 2 ) \vert$$

and Gary(n) represents the sum of the gray scale values of all the pixels on the nth line in the said pixel area, and n is a number from 3 to the total number of lines of the pixels, and u is a convert constant between the gray scale and driving voltage. The display driving circuit directly determines whether the voltage difference Δ U2 after summing in each pixel area is larger than the second threshold value G_th2. Certainly, in other embodiments, the display driving circuit can determines whether the driving voltage difference of the pixels on the same data line of each alternate rows in the pixel area is larger than a threshold, and if the driving voltage difference of the pixels on the same data line of alternate rows exceeding an predetermined amount in the pixel area is larger than a threshold, and then the voltage difference Δ U2 after summing is determined to be larger than the second threshold value G_th2.

306: the display driving circuit determines the pixel voltage distribution of the plurality of pixels not to be the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

As the pixel area of which the voltage difference Δ U2 after summing is larger than the second threshold value G_th2 in the plurality of pixels does not exist, i.e. the pixel voltage distribution of the plurality of pixels is not the second kind of distribution. In this embodiment, the display driving circuit determines the pixel voltage distribution of the plurality of pixels to be the first kind of distribution but not the second kind of distribution. Then, the pixel area of which the driving voltage difference of the pixels of adjacent rows in the inputted picture frame is larger exists, and the pixels of all rows are divided into at least two units according to four rows of each unit, and the driving sequence of the second row and the third row is switched for the each unit. For instance, the display driving circuit divides the pixels of every four rows to be one unit, and the gate driving circuit of the display driving circuit scans each unit in sequence. The gate driving circuit outputs the scan signal as shown in FIG. 5 to each unit, i.e. the scan sequence of each unit is the first, the third, the second and the fourth rows. As the scan signal Yn in FIG. 5 is high voltage level, the pixels of the nth row are activated, and CKV represents the sequence signal. The gate driving circuit activates the pixels of the first, the third, the second and the fourth rows in the said unit in sequence. Correspondingly, the source driving circuit outputs the driving voltage corresponded with the display data to the pixels of the corresponding scan row, i.e. corresponding to the scan signal shown in FIG. 5. As the source driving circuit correspondingly outputs the driving voltages corresponded with the pixel of the four rows in each pixel unit, the output sequence is the pixels of the first, the third, the second, the fourth rows in the said unit and the driving voltage corresponded with the display data in sequence.

Because the driving voltage difference corresponded with the display data of the pixels of the alternate rows in each unit which is the first kind of distribution is relatively smaller than driving voltage difference corresponded with the display data of the pixels of the adjacent rows, thus, as the display driving circuit drives and shows those which are the first kind of distribution with this step, the voltage difference change outputted by the source driving circuit output is diminished, and thus, the power consumption of the source driving circuit is diminished.

307: as the display driving circuit determines the pixel voltage distribution of the plurality of pixels to be the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

As the pixel area of which the voltage difference Δ U2 after summing is larger than the second threshold G_th2 exists in the plurality of the pixels, the pixel voltage distribution of the plurality of the pixels is the second kind of distribution. In this embodiment, the display driving circuit determines the pixel voltage distribution of the plurality of the pixels to be the first kind of distribution and the second kind of distribution. Specifically, in the aforesaid step, the pixel area of which the voltage difference Δ U1 after summing is larger than the first threshold value G_th1 and the pixel area of which the voltage difference Δ U2 after summing is larger than the second threshold value G_th2 can be different pixel areas or the same pixel area.

In this embodiment, the display driving circuit divides the pixels of all rows into at least two units according to four rows of each unit, and discards the display data to the pixels of partial rows in each unit. Discarding the display data specifically is: as fore and after driving and showing every two units, discarding the display data corresponded with pixels of partial rows in the fore unit and the display data of corresponding rest partial rows in the after unit, and using the display data of the pixels of reserve two adjacent rows in the fore unit respectively as the display data of the pixels of the two sets of two adjacent rows in the fore unit, and using the display data of the pixels of reserve two adjacent rows in the after unit respectively as the display data of the pixels of the two sets of two adjacent rows in the fore unit.

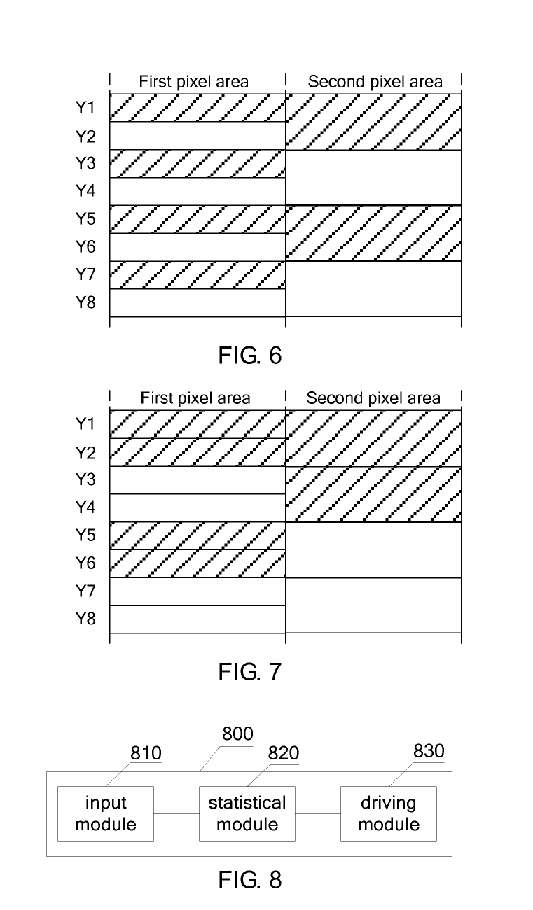

The illustration and explanation is proceeded with specifically combining FIG. 4 and FIGS. 6, 7. The pixel voltage distribution of the first pixel area in the picture frame is the first kind of distribution, and the pixel voltage distribution of the second pixel area in the picture frame is the second kind of distribution. As the gate driving circuit of the display driving circuit scans the pixels of all rows in the picture frame according to the sequence shown in FIG. 4, and the source driving circuit correspondingly outputs the driving voltage of the pixels of all rows: the pixels of all rows in the picture frame are divided to a plurality of units as 1-4, 5-8, 9-13 and so on. The two units (as shown in FIG. 6) where the pixels of 1-4th, 5-8th rows are located are illustrated. In the units where the pixels of 1-4th row are located, the display data of the third, the fourth rows is discarded and the display data of the first, the second rows is reserved. Namely, corresponding to when the gate driving circuit scan the pixels of first row, the source driving circuit outputs the driving voltage corresponded with the display data to the pixels of first row, and corresponding to when the gate driving circuit scan the pixels of second row, the source driving circuit still outputs the driving voltage corresponded with the display data to the pixels of first row, and corresponding to when the gate driving circuit scan the pixels of third row, the source driving circuit outputs the driving voltage corresponded with the display data to the pixels of second row; corresponding to when the gate driving circuit scan the pixels of fourth row, the source driving circuit still outputs the driving voltage corresponded with the display data to the pixels of second row.

In the unit where the pixels of 5-8th rows are located, the display data of the fifth, the sixth rows is discarded and the display data of the seventh, the eighth rows is reserved (equivalent to that in the units where the pixels of 1-4th row are located, the display data of the first, the second rows is discarded but the display data of the third, the fourth rows is reserved). Namely, corresponding to when the gate driving circuit scan the pixels of fifth row, the source driving circuit outputs the driving voltage corresponded with the display data to the pixels of fifth row, and corresponding to when the gate driving circuit scan the pixels of sixth row, the source driving circuit still outputs the driving voltage corresponded with the display data to the pixels of fifth row, and corresponding to when the gate driving circuit scan the pixels of seventh row, the source driving circuit outputs the driving voltage corresponded with the display data to the pixels of sixth row; corresponding to when the gate driving circuit scan the pixels of eighth row, the source driving circuit still outputs the driving voltage corresponded with the display data to the pixels of sixth row.

The display driving circuit drives the display panel to show the picture shown by 1st-8th rows as shown in FIG. 7. The pixels after 9th row are driven and shown similarly as 1st-8th rows. Compared with the original picture representing the picture frame, the picture shown in FIG. 7 reserves the display graphic features of the picture frame, and the driving voltages of at least two rows outputted by the source driving circuit are the same. The voltage difference change outputted by the source driving circuit is diminished, and thus, the power consumption of the source driving circuit is diminished.

Please refer to FIG. 8. FIG. 8 is a structural diagram of one embodiment of the display driving circuit according to the present invention. In this embodiment, the display driving circuit 800 comprises an input module 810, the statistical module 820 and a driving module 830. The driving module 830 can comprise a gate driving circuit and a source driving circuit in practical application. The gate driving circuit is employed to output the scan signal to the display unit of the display panel, and the source driving circuit is employed to output the driving voltage corresponded with the display data of the picture frame to the display unit of the display panel. The combination of the gate driving circuit and the source driving circuit realizes the driving display of the driving module 830 to the display panel. The input module 810 and the statistical module 820 can be integrated in the TCON board in practical application.

The input module 810 is employed for inputting the display data corresponding to the picture frame, and the picture frame comprises a plurality of pixels. The plurality of pixels correspond to the plurality of pixel units of the display panel.

The statistical module 820 is employed for statistically summing absolute values of gray scale/voltage differences of the pixels in a showing sequence direction of the plurality of pixels to acquire pixel gray scale/voltage distribution of the plurality of pixels according to the gray scale/voltage difference after summing.

A showing sequence of the plurality of pixels is the sequence that the display driving circuit drives the corresponding pixel units of the display panel. For instance, the display driving circuit utilizes row driving, and the showing sequence of the plurality of pixels is to show by rows.

The liquid crystal display shown in FIG. 1 is illustrated, and the display driving circuit is employed for driving the display panel shown in FIG. 1, and the showing sequence of the plurality of pixels is to show by rows. The statistical module 820 divides the plurality of pixels into pixel areas, and each pixel area comprises the pixels on at least one data line. The display driving circuit respectively calculates gray scale/voltage differences of the pixels in each pixel area in the showing sequence direction and statistically sums absolute values of gray scale/voltage differences of all the pixels in each pixel area. The statistical module 820 acquires the pixel gray scale/voltage distribution of the pixels in each pixel area according to the sum of the absolute values of the gray scale/voltage differences of the pixels in each pixel area.

The driving module 830 is employed for at least partially reducing fore and after driving voltage difference corresponded with the display data of fore and after showing pixels in a showing sequence direction of the plurality of pixels for pixel gray scale/voltage distribution of the plurality of pixels of which the gray scale/voltage difference after summing is larger than the threshold.

The step of at least partially reducing fore and after driving voltage difference corresponded with the display data of fore and after showing pixels in this embodiment can be processed by changing the driving sequence of a portion of the pixels or by discarding display data to the driving voltage differences corresponded with the display data of the portion of the pixels.

For instance, as the sum of the absolute values of the gray scale differences of the pixels on the adjacent rows in each pixel area exceeds a threshold, the pixel areas of which the gray scale differences of the pixels on the adjacent rows are larger are confirmed by the driving module 830 to be existing in the plurality of pixels. Thus, the pixels on the odd scan lines in the plurality of pixels can be driven first, and then the pixels on the even scan lines are driven, and alternatively, the pixels on every 2i adjacent scan lines in the plurality of pixels are considered as an unit, and i is larger than 1, and the display driving circuit sequentially drives each unit, and each unit is fore and after driven according to the odd and even scan lines.

For another instance, as the sum of the absolute values of the gray scale differences of the pixels on the alternate rows in each pixel area exceeds a threshold, the pixel areas of which the gray scale differences of all the pixels on the alternate rows are larger are confirmed by the driving module 830 to be existing in the plurality of pixels. Thus, the pixels on the 4jth scan line and (4j−1)th scan lines in the plurality of pixels can be driven first, and then the pixels on the rest scan lines are driven, and alternatively, the display driving circuit considers the pixels on every 4 adjacent scan lines in the plurality of pixels as an unit, and sequentially drives each unit, and adjacent two units are driven by driving voltages of the pixels on two different scan lines.

In practical application, the number of the source driving circuits in the driving module 830 can be many, and each source driving circuit drives the pixel units on a portion of the data lines of the display panel. Then, preferably, the display driving circuit can considers the pixel units correspondingly driven by each source driving circuit as one pixel area. Therefore, the driving module 830 can confirm the gray scale/voltage distribution of the pixel units driven by the each source driving circuit. Thus, as the gray scale/voltage distribution of which the gray scale/voltage differences after summing of the pixel units driven by one source driving circuit is larger than the threshold exists, then the driving module 830 by at least changing the driving sequence of the pixels driven by the source driving circuit of which the gray scale/voltage distribution exists or by discarding display data to the pixels driven by the source driving circuit of which the gray scale/voltage distribution exists, achieves to at least partially reduce fore and after driving voltage difference corresponded with the display data of fore and after showing pixels of the source driving circuit of which the gray scale/voltage distribution exists.

It is understandable that the aforesaid illustration is combined with the display panel shown in FIG. 1. Each scan line of the display panel is connected to pixel units of a row, and each scan line comprises the pixel units of all the pixel areas thereon. Consequently, as the gray scale/voltage difference after summing of the pixel area in the plurality of pixels is larger than the threshold, the pixels on the scan line in the all pixel areas are adjusted as the display driving module adjusts the driving sequence on the scan line or discards display data. In other embodiments, supposing the scan line of the display panel is not connected to the pixel units of the entire row, such as each scan line is only connected to one or three pixel units of the display panel, as the gray scale/voltage difference after summing of the pixel area in the plurality of pixels is larger than the threshold, the driving module can change the driving sequence of the pixels connected to the scan line only in the pixel area of which the gray scale/voltage difference after summing of the pixel area is larger than the threshold, or discard display data to the pixels connected to the scan line in the pixel area of which the gray scale/voltage difference after summing of the pixel area is larger than the threshold.

Preferably, the statistical module 820 is specifically employed for: as rank scan driving and showing the plurality of pixels, summing absolute values of driving voltage differences required for pixels of the next row and the present row on the same data line in the plurality of pixels row by row; as the voltage difference Δ U1 after summing is larger than the first threshold value G_th1, the pixel voltage distribution of the plurality of pixels is determined to be the first kind of distribution.

For instance, the statistical module 820 sums the absolute values of gray scale differences required for the pixels of the next row and the present row in each pixel unit row by row,

$$Δ U 1 = u {\sum }_{n} \vert Gary ( n ) \text{-} Gary ( n - 1 ) \vert$$

and Gary(n) represents the sum of the gray scale values of all the pixels on the nth line in the said pixel area, and n is a number from 2 to the total number of lines of the pixels, and u is a convert constant between the gray scale and driving voltage. The statistical module 820 directly determines whether the voltage difference Δ U1 after summing in each pixel area is larger than the first threshold value G_th1. As the pixel area of which the voltage difference Δ U1 after summing is larger than the first threshold value G_th1 in the plurality of pixels does not exist, the pixel voltage distribution of the plurality of pixels is not the first kind of distribution. As the pixel area of which the voltage difference Δ U1 after summing is larger than the first threshold G_th1 exists in the plurality of the pixels, the pixel voltage distribution of the plurality of the pixels is the first kind of distribution. Certainly, in other embodiments, the statistical module can determines whether the driving voltage difference of the pixels on the same data line of each adjacent rows in the pixel area is larger than a threshold, and if the driving voltage difference of the pixels on the same data line of adjacent rows exceeding an predetermined amount in the pixel area is larger than a threshold, and then the voltage difference Δ U1 after summing is determined to be larger than the first threshold value G_th1.

Preferably, the statistical module 820 is also specifically employed for: as rank scan driving and showing the plurality of pixels, summing absolute values of driving voltage differences required for pixels of the row after the next row and the present row on the same data line in the plurality of pixels row by row; as the voltage difference Δ U2 after summing is larger than the second threshold value G_th2, the pixel voltage distribution of the plurality of pixels is determined to be the second kind of distribution.

For instance, as the statistical module 820 determines the pixel voltage distribution of the plurality of the pixels to be the first kind of distribution, and then, the statistical module sums the absolute values of gray scale differences required for the pixels of the row after the next row and the present row in each pixel unit row by row,

$$Δ U 1 = u {\sum }_{n} \vert Gary ( n ) \text{-} Gary ( n - 2 ) \vert$$

and Gary(n) represents the sum of the gray scale values of all the pixels on the nth line in the said pixel area, and n is a number from 3 to the total number of lines of the pixels, and u is a convert constant between the gray scale and driving voltage. The statistical module 820 directly determines whether the voltage difference Δ U2 after summing in each pixel area is larger than the second threshold value G_th2. As the pixel area of which the voltage difference Δ U2 after summing is larger than the second threshold value G_th2 in the plurality of pixels does not exist, the pixel voltage distribution of the plurality of pixels is not the second kind of distribution. As the pixel area of which the voltage difference Δ U2 after summing is larger than the second threshold G_th2 exists in the plurality of the pixels, the pixel voltage distribution of the plurality of the pixels is the second kind of distribution. Certainly, in other embodiments, the display driving circuit can determines whether the driving voltage difference of the pixels on the same data line of each alternate rows in the pixel area is larger than a threshold, and if the driving voltage difference of the pixels on the same data line of alternate rows exceeding an predetermined amount in the pixel area is larger than a threshold, and then the voltage difference Δ U2 after summing is determined to be larger than the second threshold value G_th2.

Preferably, the step of at least partially reducing fore and after driving voltage difference corresponded with the display data of fore and after showing pixels in the showing sequence direction of the plurality of pixels executed by the driving module 830 specifically comprises: as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

Specifically, the pixel area of which the voltage difference Δ U1 after summing is larger than the first threshold value G_th1 and the pixel area of which the voltage difference Δ U2 after summing is larger than the second threshold value G_th2 that the statistical module 820 determines can be different pixel areas or the same pixel area.

In this embodiment, as the pixel voltage distribution of the plurality of pixels is the first kind of distribution and the second kind of distribution, the driving module 830 divides the pixels of all rows into at least two units according to four rows of each unit, and as fore and after driving and showing every two units, discarding the display data corresponded with pixels of partial rows in the fore unit and the display data of corresponding rest partial rows in the after unit, and using the display data of the pixels of reserve two adjacent rows in the fore unit respectively as the display data of the pixels of the two sets of two adjacent rows in the fore unit, and using the display data of the pixels of reserve two adjacent rows in the after unit respectively as the display data of the pixels of the two sets of two adjacent rows in the fore unit.

The illustration and explanation is proceeded with specifically combining FIG. 4 and FIGS. 6, 7. The pixel voltage distribution of the first pixel area in the picture frame is the first kind of distribution, and the pixel voltage distribution of the second pixel area in the picture frame is the second kind of distribution. As the gate driving circuit of the driving module 830 scans the pixels of all rows in the picture frame according to the sequence shown in FIG. 4, and the source driving circuit of the driving module 830 correspondingly outputs the driving voltage of the pixels of all rows: the pixels of all rows in the picture frame are divided to a plurality of units as 1-4, 5-8, 9-13 and so on. The two units (as shown in FIG. 6) where the pixels of 1-4th, 5-8th rows are located are illustrated. In the units where the pixels of 1-4th row are located, the display data of the third, the fourth rows is discarded and the display data of the first, the second rows is reserved. Namely, corresponding to when the gate driving circuit scan the pixels of first row, the source driving circuit outputs the driving voltage corresponded with the display data to the pixels of first row, and corresponding to when the gate driving circuit scan the pixels of second row, the source driving circuit still outputs the driving voltage corresponded with the display data to the pixels of first row, and corresponding to when the gate driving circuit scan the pixels of third row, the source driving circuit outputs the driving voltage corresponded with the display data to the pixels of second row; corresponding to when the gate driving circuit scan the pixels of fourth row, the source driving circuit still outputs the driving voltage corresponded with the display data to the pixels of second row.

In the unit where the pixels of 5-8th rows are located, the display data of the fifth, the sixth rows is discarded and the display data of the seventh, the eighth rows is reserved (equivalent to that in the units where the pixels of 1-4th row are located, the display data of the first, the second rows is discarded but the display data of the third, the fourth rows is reserved). Namely, corresponding to when the gate driving circuit scan the pixels of fifth row, the source driving circuit outputs the driving voltage corresponded with the display data to the pixels of fifth row, and corresponding to when the gate driving circuit scan the pixels of sixth row, the source driving circuit still outputs the driving voltage corresponded with the display data to the pixels of fifth row, and corresponding to when the gate driving circuit scan the pixels of seventh row, the source driving circuit outputs the driving voltage corresponded with the display data to the pixels of sixth row; corresponding to when the gate driving circuit scan the pixels of eighth row, the source driving circuit still outputs the driving voltage corresponded with the display data to the pixels of sixth row.

The display driving circuit drives the display panel to show the picture shown by 1st-8th rows as shown in FIG. 7. The pixels after 9th row are shown similarly as 1st-8th rows. Compared with the original picture representing the picture frame, the picture shown in FIG. 7 reserves the display graphic features of the picture frame, and the driving voltages of at least two rows outputted by the source driving circuit are the same. The voltage difference change outputted by the source driving circuit is diminished, and thus, the power consumption of the source driving circuit is diminished.

Preferably, the step of at least partially reducing fore and after driving voltage difference corresponded with the display data of fore and after showing pixels in the showing sequence direction of the plurality of pixels executed by the driving module 830 specifically comprises: as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

For instance, the statistical module 820 confirms the pixel voltage distribution of the plurality of pixels to be the first kind of distribution but not the second kind of distribution the driving module 830 divides the pixels of every four rows to be one unit, and the gate driving circuit of the driving module 830 scans each unit in sequence. The gate driving circuit outputs the scan signal as shown in FIG. 5 to each unit, i.e. the scan sequence of each unit is the first, the third, the second and the fourth rows. Correspondingly, the source driving circuit of the driving module 830 outputs the driving voltage corresponded with the display data to the pixels of the corresponding scan row, i.e. corresponding to the scan signal shown in FIG. 5. As the source driving circuit correspondingly outputs the driving voltages corresponded with the pixel of the four rows in each pixel unit, the output sequence is the pixels of the first, the third, the second, the fourth rows in the said unit and the driving voltage corresponded with the display data in sequence.

Because the driving voltage difference corresponded with the display data of the pixels of the alternate rows in each unit which is the first kind of distribution is relatively smaller than driving voltage difference corresponded with the display data of the pixels of the adjacent rows, thus, as the display driving circuit drives and shows those which are the first kind of distribution with this step, the voltage difference change outputted by the source driving circuit output is diminished, and thus, the power consumption of the source driving circuit is diminished.

The driving module 830 is also employed to drive the pixels of each row in sequence as the pixel voltage distribution of the plurality of pixels is not the first kind of distribution. For instance, the gate driving circuit of the driving module 830 outputs scan signals as shown in FIG. 4 corresponding to the output end of each scan line, to scan the plurality of pixels in sequence row by row, and the source driving circuit of the driving module 830 outputs driving voltage of the pixels of corresponding row in accordance with the sequence of the gate driving circuits according to the pixel gray scale of the picture frame to realize showing the picture represented by the picture frame.

The present invention further provides a liquid crystal display, and the liquid crystal display comprises a display driving circuit and a display panel, and the display driving circuit outputs a driving voltage corresponding to display data of a picture frame to the display panel to drive the display panel to show a picture corresponding to the picture frame. Specifically, the display driving circuit is the display driving circuit in the aforesaid embodiments. Thus, the repeated description is omitted here.

In the aforesaid solutions, by statistically summing absolute values of gray scale/voltage differences of the pixels in a showing sequence direction of the pixels of the picture frame to acquire pixel gray scale/voltage distribution of the picture frame, and by at least partially reducing fore and after driving voltage difference corresponded with the display data of fore and after showing pixels in the showing sequence direction of the plurality of pixels for pixel gray scale/voltage distribution of the plurality of pixels of which the gray scale/voltage difference after summing is larger than the threshold. Thus, the driving voltage change that the display driving circuit outputs to the portion of the fore and after showing pixels is diminished, and the power consumption of the display driving circuit is reduced.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal display, comprising a display driving circuit and a display panel, and the display driving circuit outputs a driving voltage corresponding to display data of a picture frame to the display panel to drive the display panel to show a picture corresponding to the picture frame;
the display driving circuit comprises:
an input module, employed for inputting the display data corresponding to the picture frame, and the picture frame comprises a plurality of pixels;
a statistical module, employed for as rank scan driving and showing the plurality of pixels, summing absolute values of driving voltage differences required for pixels of the next row and the present row on the same data line in the plurality of pixels row by row; as a voltage difference Δ U1 after summing is larger than a first threshold value G_th1, the pixel voltage distribution of the plurality of pixels is determined to be a first kind of distribution, and as rank scan driving and showing the plurality of pixels, summing absolute values of driving voltage differences required for pixels of the row after the next row and the present row on the same data line in the plurality of pixels row by row; as a voltage difference Δ U2 after summing is larger than a second threshold value G_th2, the pixel voltage distribution of the plurality of pixels is determined to be a second kind of distribution;
a driving module, employed for at least partially reducing fore and after driving voltage difference corresponded with the display data of fore and after showing pixels in a showing sequence direction of the plurality of pixels as the gray scale/voltage difference after summing is larger than pixel gray scale/voltage distribution of the plurality of pixels.

2. The liquid crystal display according to claim 1, wherein
the statistical module is specifically employed for: as rank scan driving and showing the plurality of pixels, summing absolute values of driving voltage differences required for pixels of the next row and the present row on the same data line in the plurality of pixels row by row; as the voltage difference Δ U1 after summing is larger than the first threshold value G_th1, the pixel voltage distribution of the plurality of pixels is determined to be the first kind of distribution.

3. The liquid crystal display according to claim 2, wherein
the statistical module is specifically employed for: as rank scan driving and showing the plurality of pixels, summing absolute values of driving voltage differences required for pixels of the row after the next row and the present row on the same data line in the plurality of pixels row by row; as the voltage difference Δ U2 after summing is larger than the second threshold value G_th2, the pixel voltage distribution of the plurality of pixels is determined to be the second kind of distribution.

4. The liquid crystal display according to claim 3, wherein
at least partially reducing fore and after driving voltage difference corresponded with the display data of fore and after showing pixels in the showing sequence direction of the plurality of pixels executed by the driving module specifically comprises:
as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

5. The liquid crystal display according to claim 3 or 4, wherein
at least partially reducing fore and after driving voltage difference corresponded with the display data of fore and after showing pixels in the showing sequence direction of the plurality of pixels executed by the driving module specifically comprises:
as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

6. A display driving method, comprising steps of:
inputting the display data corresponding to the picture frame, and the picture frame comprises a plurality of pixels;
statistically summing absolute values of gray scale/voltage differences of the pixels in a showing sequence direction of the plurality of pixels to acquire pixel gray scale/voltage distribution of the plurality of pixels according to the gray scale/voltage difference after summing;
at least partially reducing fore and after driving voltage difference corresponded with the display data of fore and after showing pixels in a showing sequence direction of the plurality of pixels as the gray scale/voltage difference after summing is larger than pixel gray scale/voltage distribution of the plurality of pixels.

7. The display driving method according to claim 6, wherein
the step of statistically summing absolute values of gray scale/voltage differences of the pixels in a showing sequence direction of the plurality of pixels comprises:
as rank scan driving and showing the plurality of pixels, summing absolute values of driving voltage differences required for pixels of the next row and the present row on the same data line in the plurality of pixels row by row;
the step of acquiring pixel gray scale/voltage distribution of the plurality of pixels according to the gray scale/voltage difference after summing comprises:
as a voltage difference Δ U1 after summing is larger than a first threshold value G_th1, the pixel voltage distribution of the plurality of pixels is determined to be a first kind of distribution.

8. The display driving method according to claim 7, wherein
the step of statistically summing absolute values of gray scale/voltage differences of the pixels in a showing sequence direction of the plurality of pixels comprises:
as rank scan driving and showing the plurality of pixels, summing absolute values of driving voltage differences required for pixels of the row after the next row and the present row on the same data line in the plurality of pixels row by row;
the step of acquiring pixel gray scale/voltage distribution of the plurality of pixels according to the gray scale/voltage difference after summing comprises:
as a voltage difference Δ U2 after summing is larger than a second threshold value G_th2, the pixel voltage distribution of the plurality of pixels is determined to be a second kind of distribution.

9. The display driving method according to claim 8, wherein
the step of at least partially reducing fore and after driving voltage difference corresponded with the display data of fore and after showing pixels in the showing sequence direction of the plurality of pixels comprises:
as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

10. The display driving method according to claim 8 or 9, wherein
the step of at least partially reducing fore and after driving voltage difference corresponded with the display data of fore and after showing pixels in the showing sequence direction of the plurality of pixels comprises:
as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.

11. A display driving circuit, comprising:
an input module, employed for inputting the display data corresponding to the picture frame, and the picture frame comprises a plurality of pixels;
a statistical module, employed for statistically summing absolute values of gray scale/voltage differences of the pixels in a showing sequence direction of the plurality of pixels to acquire pixel gray scale/voltage distribution of the plurality of pixels according to the gray scale/voltage difference after summing;
a driving module, employed for at least partially reducing fore and after driving voltage difference corresponded with the display data of fore and after showing pixels in a showing sequence direction of the plurality of pixels as the gray scale/voltage difference after summing is larger than pixel gray scale/voltage distribution of the plurality of pixels.

12. The display driving circuit according to claim 11, wherein
the statistical module is specifically employed for: as rank scan driving and showing the plurality of pixels, summing absolute values of driving voltage differences required for pixels of the next row and the present row on the same data line in the plurality of pixels row by row; as the voltage difference Δ U1 after summing is larger than the first threshold value G_th1, the pixel voltage distribution of the plurality of pixels is determined to be the first kind of distribution.

13. The display driving circuit according to claim 12, wherein
the statistical module is specifically employed for: as rank scan driving and showing the plurality of pixels, summing absolute values of driving voltage differences required for pixels of the row after the next row and the present row on the same data line in the plurality of pixels row by row; as the voltage difference Δ U2 after summing is larger than the second threshold value G_th2, the pixel voltage distribution of the plurality of pixels is determined to be the second kind of distribution.

14. The display driving circuit according to claim 13, wherein
at least partially reducing fore and after driving voltage difference corresponded with the display data of fore and after showing pixels in the showing sequence direction of the plurality of pixels executed by the driving module specifically comprises:
as the pixel voltage distribution of the plurality of pixels is determined to be the first kind of distribution and the second kind of distribution, the pixels of all rows are divided into at least two units according to four rows of each unit, and as fore and after driving and showing the at least two units, alternately discarding display data corresponded with pixels of partial rows in the fore unit and display data of corresponding rest partial rows in the after unit, and using display data of the pixels of reserve rows in the fore unit as display data of the pixels of the rest rows in the fore unit, and similarly operating the after unit to partially reduce fore and after driving voltage difference corresponded with the display data of fore and after showing pixels.

15. The display driving circuit according to claim 13 or 14, wherein
at least partially reducing fore and after driving voltage difference corresponded with the display data of fore and after showing pixels in the showing sequence direction of the plurality of pixels executed by the driving module specifically comprises:
as the pixel voltage distribution of the plurality of pixels is determined to be the first kind of distribution but not the second kind of distribution, the pixels of all rows are divided into at least two units according to four rows of each unit, the driving sequence of the second row and the third row is switched for the each unit to partially reduce fore and after driving voltage difference corresponded with the display data of fore and after showing pixels.
